(19) United States
(12) Patent Application Publication
(10) Pub. No.: US 2006/0157471 A1
(43) Pub. Date: Jul. 20, 2006

(54) WARMING DEVICE FOR WARMING A FLUID MAINTAINED IN A FLUID-CONTAINING RECEPTACLE AND USE THEREOF

(76) Inventors: Curtis P. Taylor, Moreland Hills, OH (US); Justin S. Rerko, Strongsville, OH (US); Stephen Mika, Chagrin Falls, OH (US)

Correspondence Address: Justin S. Rerko & Associates, LLC, 19836 Ellsworth Drive, Strongsville, OH, 44149, US

(21) Appl. No.: 11/037,804

(22) Filed: Jan. 19, 2005

(51) Int. Cl. F27D 11/00

(52) U.S. Cl. 219/433

(57) ABSTRACT

A warming device adapted to receive and support a commercially provided fluid-containing receptacle, such as a body lotion-containing receptacle, and to warm the fluid, such as the body lotion, maintained therein so that the fluid may be withdrawn therefrom in a warmed state. The device generally includes a securing means adapted for securing a fluid-containing receptacle; and a warming means, associated with the securing means, adapted for warming the fluid maintained in the fluid-containing receptacle. The securing means may suitably comprise a base member adapted for receiving the receptacle thereon; a first substantially vertically oriented panel, associated with the base member in a substantially perpendicular manner, adapted to interface with at least a portion of a front face of the receptacle; and a second substantially vertically oriented panel, associated with the base member in a substantially perpendicular manner, adapted to interface with at least a portion of a rear face of the receptacle, wherein the second panel is adjustable relative to the first panel along a continuum of positions disposed on the base member. The warming means is preferably associated with at least one of the first panel and the second panel,

### FIELD OF THE INVENTION

The present invention is directed to a warming device for warming a fluid maintained in a fluid-containing receptacle and use thereof. More particularly, the present invention is directed to a warming device adapted to support a commercially available fluid-containing receptacle, such as a hand lotion receptacle, and warm the fluid, such as the hand lotion, maintained therein.

### BRIEF DISCUSSION OF THE RELATED ART

Fluids, particularly fluids adapted for bodily application and/or use, such as, for example, hand lotion, body lotion, liquid soap, cosmetics, toothpaste, etc., are frequently employed by individuals for a number of applications, such as therapeutic use, cosmetic use, cleansing use, general comfort, and the like. According to conventional approaches, such fluids are typically packaged into a receptacle, such as a typical upright standing, plastic-based, generally rectangular and partially elliptical body having a dispenser apparatus associated therewith. Of particular note, the receptacles usually include a broad vertical face, which is typically employed by manufacturers and marketers of the fluid as a substrate upon which artistic labels and other brand goodwill-generating features are placed. The fluid typically remains in the commercially provided receptacle and a desired amount is periodically withdrawn therefrom for use through actuation of the dispenser apparatus. Such receptacles are typically designed so as to be discarded once the fluid therein has been exhausted; accordingly, individuals by convention generally do not transfer the fluid from the commercially provided receptacle to an alternate storage receptacle.

Despite the generally ubiquitous use of fluids, particularly the body application fluids, their use, particularly their application to bodily surfaces, suffers from a significant drawback. As known, an individual's body is maintained at a temperature that is typically significantly higher than the temperature of the environment in which the individual exists. Accordingly, bodily contact with a substance, such as a fluid, maintained at a temperature lower than the temperature of the individual's body will be an initially unpleasant experience, as the disparity of temperatures will cause discomfort until the substance's temperature is elevated to near body temperatures. The application of fluids, particularly body application fluids, is prone to cause such temperature disparity-based discomfort, given the conventional positioning and/or storage of fluid-containing receptacles in non-elevated temperature environments. Thus, it would be advantageous to be able to elevate the temperature of a fluid, particularly a body application fluid, prior to its application onto bodily surfaces.

U.S. Pub. No. 2002/0108965 to Hill et al., assigned on its face to Conair CIP, Inc. discloses a device for warming and dispensing a fluid. The disclosed device generally includes a reservoir into which a selected fluid is transferred from the commercially provided receptacle, which receptacle is associated with a heating element and a dispensing apparatus. The fluid is warmed in the reservoir and dispensed in a warm state from the device dispensing apparatus.

The Hill et al. reference is a particularly disadvantageous device for warming a fluid. In one aspect, the fluid must be transferred from the commercially provide receptacle to the device reservoir. This approach alone creates several complications. For one, the transfer of fluid between the receptacle and the reservoir is likely to involve generation of mess, loss of fluid, and wasted time required for cleaning the mess. For another, the effort expended by fluid manufacturers and marketers in creating appealing and brand goodwill-generating labels is wasted, as the provided receptacle and its labels are typically discarded, thereby eliminating the ongoing branding and goodwill generating opportunities associated with an individual periodically dispensing fluid from the commercially provided receptacle and observing the labels thereon. In another aspect, the viscous nature of typically used fluids interferes with the ability of the device to fully dispense the entirety of the contents of its reservoir. In another aspect, the Hill et al. device does not permit the rapid and easy switching of fluids in the reservoir, as fluids already present in the reservoir must be removed (and typically discarded) and the reservoir and its dispensing apparatus must be thoroughly cleaned and the original fluid purged therefrom, lest an undesirable amount of new fluid and original fluid intermingling occur. Thus, there exists a need for a warming device adapted to receive a commercially provided fluid-containing receptacle, display the contents of any labels affixed thereto, and warm the fluid therein so that the fluid may be obtained therefrom, preferably dispensed through the receptacle's integral dispensing apparatus, in a warmed state for increased comfort in bodily application or other appropriate use.

### BRIEF SUMMARY OF THE INVENTION

In accordance with one example aspect, the present invention is directed to a body lotion warming device adapted to receive and support a commercially provided body lotion-containing receptacle and to warm the body lotion maintained therein so that the body lotion may be withdrawn therefrom in a warmed state. The warming device generally includes a securing means adapted for securing a fluid-containing receptacle; and a warming means, associated with the securing means, adapted for warming the fluid maintained in the fluid-containing receptacle.

In accordance with another example aspect, the present invention is directed to a warming device adapted to receive and support a commercially provided fluid-containing receptacle and to warm the fluid maintained therein so that the fluid may be withdrawn therefrom in a warmed state. The device generally includes a securing means adapted for securing a fluid-containing receptacle; and a warming means, associated with the securing means, adapted for warming the fluid maintained in the fluid-containing receptacle.

In accordance with yet another example aspect, the present invention is directed to a body lotion warming device adapted to receive and support a commercially provided body lotion-containing receptacle and to warm the body lotion maintained therein so that the body lotion may be withdrawn therefrom in a warmed state. The warming device generally includes a base member adapted for receiving the receptacle thereon; a first panel, associated with the base member, adapted to interface with at least a portion of a front face of the receptacle; a second panel, associated with the base member, adapted to interface with at least a portion of a rear face of the receptacle, wherein the second panel is adjustable relative to the first panel along a continuum of positions disposed on the base member; a warming means, associated with at least one of the first panel and the second panel, adapted for warming the fluid maintained in the fluid-containing receptacle; and a coupling means adapted for coupling the warming means to a source of electrical current.

### BRIEF DESCRIPTION OF THE DRAWINGS

These and other features and a more thorough understanding of the present invention may be achieved by referring to the following description and claims, taken in conjunction with the accompanying drawings, wherein:

FIG. 1 is a perspective view of an example warming device, according to the present invention;

FIG. 2 is a perspective view of the example warming device of FIG. 1 supporting an example fluid-containing receptacle; and

FIG. 3 is a side view of the example warming device and receptacle of FIGS. 1 and 2.

### DETAILED DISCUSSION OF EXAMPLE EMBODIMENTS

Disclosed according to the present invention are warming devices, and uses thereof, adapted to receive and support a commercially-provided fluid-containing receptacle and to warm the fluid therein so that the fluid may be obtained therefrom, preferably dispensed through the receptacle's integral dispensing apparatus, in a warmed state for increased comfort in bodily application or other appropriate use. In particular, the warming device is adapted to receive and support any of a plurality of receptacles and configurations thereof in which fluids are packaged and commercially marketed. Accordingly, the warming device suitably enables an individual to warm a fluid in a receptacle without removing the fluid from the receptacle and transferring the fluid to a separate warming reservoir. Example fluids warmable by the warming device of the present invention include, but are not limited to, bodily products, such as, for example, hand lotion, body lotion, body wash, liquid soap, shaving cream, shaving gels, toothpaste, fluid-based cosmetics, etc., non-bodily cleaning products such as, for example, window cleaner, general surface (e.g., floor, countertop, etc.) cleaners, and any other fluid that may benefit from being warmed. The devices of the present invention suitably also provide for the display and ready inspection of any labels affixed to a surface of the receptacle, thereby complementing commercial fluid providers' efforts in branding and goodwill generation. The devices of the present invention suitably also facilitates the withdrawal, particularly dispensing, of fluid from a reservoir as the application of heat reduces the viscosity of the fluid therein.

As will be described hereinafter, the warming devices of the present invention is particularly adapted to rest upon a surface, such as a countertop, especially a bathroom countertop, while supporting a fluid-containing receptacle therewith. Accordingly, the device is configured so as to position the receptacle in a frequently encountered and/or used area. Conventional marketing knowledge dictates that a consumer is more likely to use a product, such as hand lotion, if the product is maintained in an area of easy and frequent access, such as atop a bathroom countertop, rather than if the product is relegated to a drawer or other storage site. In fact, market knowledge indicates that the presence of the product in an area of easy and frequent access may cause a four to five times increase in use, relative to the positioning of the product in an area of uneasy and/or infrequent access. Therefore, the warming devices of the present invention is a suitably advantageous complement for commercial providers and marketers of fluids, particularly body application fluids, given the devices' ability to increase use of the fluid product and to, preferably, display any and all marketing information contained on the fluid product receptacle.

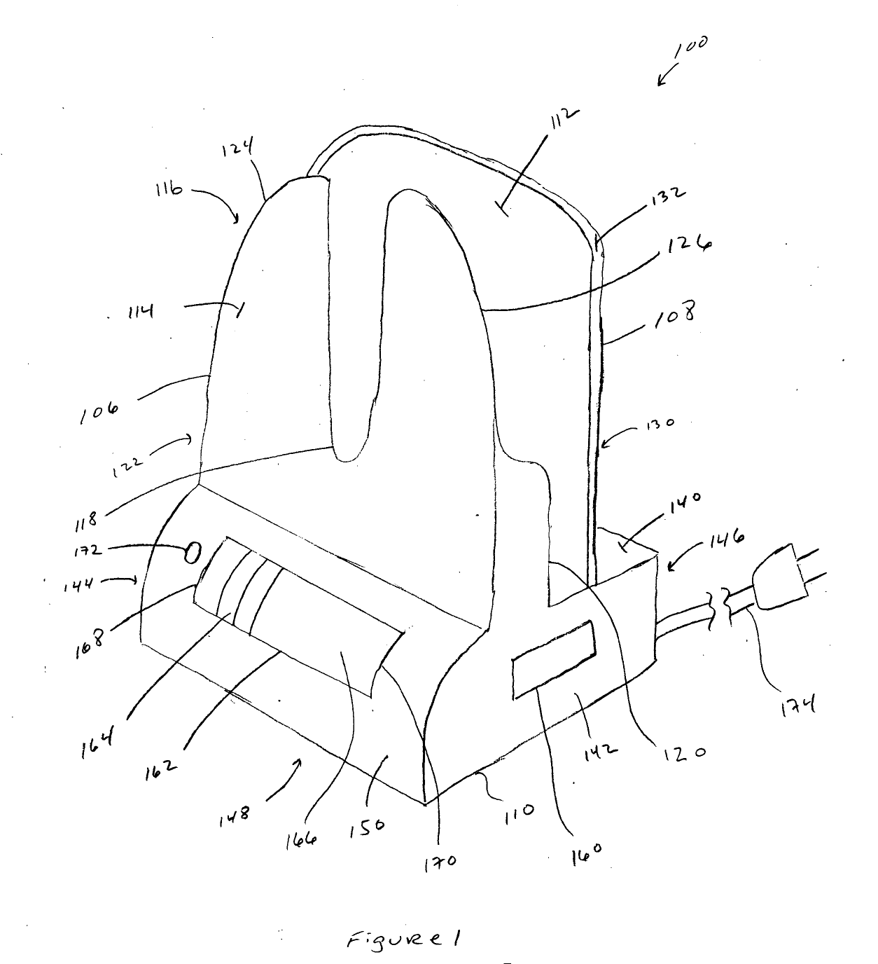

Turning to FIGS. 1, 2 and 3, illustrated is an example embodiment of a warming device 100 adapted for supporting a fluid-containing receptacle 102 and for warming the fluid maintained therein. The example warming device 100 generally includes a means adapted for supporting the fluid-containing receptacle 102 and a means adapted for warming the fluid maintained in the receptacle 102. In a preferred embodiment, the device 100 is adapted to support a body lotion-containing receptacle, particularly a generally rectangular receptacle having a dispenser apparatus associated with an upper end thereof for enabling a user to periodically dispense an amount of body lotion from the receptacle 102, and to warm the body lotion maintained therein so that the lotion may be dispensed in a warmed and more pleasing to the touch manner. Accordingly, reference will be made throughout this disclosure to a preferred body lotion receptacle embodiment of the fluid-containing receptacle 102. However, it is to be appreciated that the reference is by way of example only and for ease of illustration and is not to be construed as a limitation on the scope of the invention. The warming device 100 of the present invention is particularly amenable to interacting with any of a plurality of receptacle configurations and warming any of a plurality of fluids.

With continued reference to the Figures, the means adapted for supporting the fluid-containing receptacle 102 is preferably provided as a gripping member configured to receive the receptacle 102 and to support the receptacle 102 in a predetermined configuration. In connection with the preferred body lotion dispensing receptacle 102 embodiment, the gripping member is configured to receive the lotion dispensing receptacle 102 and support the receptacle 102 in an upright position, thereby positioning the dispensing apparatus for easy manipulative access.

In a preferred embodiment, the gripping member is provided as a pair of vertically oriented and spaced apart panels 106, 108 adapted for receiving and supporting the receptacle 102 therebetween. More preferably, the gripping member is provided as a pair of separate components consisting of a stationary panel 106 and an adjustable panel 108. The stationary panel 106 is preferably a member unitary with the warming device 100 and is not moveable relative to the warming device 100. The adjustable panel 108 is preferably a member moveably disposed relative to the warming device 100 and is adapted to be adjusted between a position of general parallel disposition and in proximity to the stationary panel 106 and a position of general parallel disposition and relatively distal to the stationary panel 106. In operation and as will be more fully discussed below, the adjustable panel 108 is separable away from the stationary panel 106 so as to accommodate the reception of the receptacle 102 therebetween and is subsequently adjustable toward the stationary panel 106 so as to cause the receptacle 102 to be securely gripped by the panels 106, 108. It is to be appreciated, however, that both panels 106, 108 may suitable be moveable components of the warming device 100, that the orientation of panels 106, 108, particularly with regard to a moving and a stationary panel, may be inverted, and the like.

The stationary panel 106 is preferably a generally rectangular member disposed in a generally vertical orientation relative to the warming device 100 and includes an inner surface 116 and an outer surface 114. The inner surface 116 is preferably a surface of the stationary panel 106 that is positioned in generally abutting and/or proximally spaced apart relationship to the receptacle 102 when received in the warming device 100. The outer surface 114 is preferably a surface disposed in generally parallel relationship to the inner surface 116 and is oriented in opposition to the inner surface 116. Thus, in operation, the stationary panel 106 is preferably disposed in an orientation according to which a front, vertical (and preferably label-bearing) surface of the receptacle 102 is in a generally parallel, preferably parallel and generally abutting, relationship relative to the inner surface 116 of the stationary panel 106.

The stationary panel 106 is preferably provided in dimensions sufficient for causing the stationary panel 106 to interface with the front, vertical surface of the receptacle 102. More preferably, the stationary panel 106 is provided in dimensions sufficient for causing the stationary panel 106 to interface with substantially all of the front, vertical surface of the receptacle 102. Additionally, the stationary panel 106 is preferably characterized by a configuration that generally mirrors the overall configuration of the receptacle 102 so as to increase the aesthetic appeal of the warming device 100 when in receipt of the receptacle 102. Accordingly, the stationary panel 106 may suitably comprise a pair of arcuate portions 124, 126 along an upper surface thereof, which arcuate portions 124, 126 are adapted to lie in spaced apart relationship to corresponding arcuate portions along an upper surface of the receptacle 102. The arcuate portions 124, 126 preferably extend collinearly with the longitudinal axis of the stationary panel 106.

The stationary panel 106 may suitably also include additional structure for increasing the extent of surface interaction between the stationary panel 106 and the receptacle 102. In a preferred embodiment, the stationary panel 106 includes a pair of flange-like arm members 120, 122 integral with the stationary panel 106 and extending generally perpendicularly from the edges thereof toward the adjustable panel 108. The arm members 120, 122 preferably extend from the stationary panel 106 in an orientation according to which the inner surface 116 of the stationary panel 106 and the arm members 120, 122 collectively interface with a front and side faces of the receptacle 102, thereby increasing the degree of securement between the warming device 100 and the receptacle 102. Even more preferably, the arm members 120, 122 extend only from lower portions of the edges of the stationary panel 106, thereby resulting in upper portions of the side faces of the receptacle 102 being exposed when the receptacle 102 is secured by the warming device 100, which exposure suitably facilitates removal of the receptacle 102 from the warming device 100.

The stationary panel 106 may suitably also include features for allowing indicia, such as a manufacturer's label, present on the front face of the receptacle 102 to be exposed and viewable when the receptacle 102 is secured by the warming device 100. In a preferred embodiment, the stationary panel 106 is constructed of a transparent material, generally window-like in overall operation, which enables full viewing of the front face of the receptacle 102. In an alternate preferred embodiment, the stationary panel 106 includes an aperture, a longitudinally extending slit-like opening 118, or the like fashioned therein for directly exposing the front face of the receptacle 102. Additionally, the stationary panel 106 may suitably feature both a transparent material and an aperture-like opening for exposing the front face of the receptacle 102 for display and inspection. The ability to enable viewing of the front face of the receptacle 102 is particularly advantageous in connection with the warming device's 100 use in warming body lotion receptacles, given the conventional emphasis placed on exploiting the marketing potential of the front face through such efforts as distinguishing and artwork-bearing labels.

The warming device 100 suitably also includes the adjustable panel 108 for cooperating with the stationary panel 106 in the receipt and securement of the receptacle 102. The adjustable panel 108 is preferably a component having a configuration similar to, more preferably substantially similar to, the stationary panel 106. Accordingly, the adjustable panel 108 is preferably a generally rectangular member disposed in a generally vertical orientation relative to the warming device 100 and generally includes an inner surface 132 and an outer surface 130. The inner surface 132 is preferably a surface of the adjustable panel 108 that is positioned in generally abutting and/or proximally spaced apart relationship to the receptacle 102 when received in the warming device 100. The outer surface 130 is preferably a surface disposed in generally parallel relationship to the inner surface 132 and is oriented in opposition to the inner surface 132. Thus, in operation, the adjustable panel 108 is preferably disposed in an orientation according to which a rear, vertical (and potentially label-bearing) surface of the receptacle 102 in a generally parallel, preferably parallel and generally abutting, relationship relative to the inner surface 132 of the adjustable panel 108.

The adjustable panel 108 is preferably provided in dimensions sufficient for causing the adjustable panel 108 to interface with the rear, vertical surface of the receptacle 102. More preferably, the adjustable panel 108 is provided in dimensions sufficient for causing the adjustable panel 108 to interface with substantially all of the rear, vertical surface of the receptacle 102. Additionally, the adjustable panel 108 is preferably characterized by a configuration that generally mirrors the overall configuration of the receptacle 102 so as to increase the aesthetic appeal of the warming device 100 when in receipt of the receptacle 102. Accordingly, the adjustable panel 108 may suitably comprise a pair of arcuate portions along an upper surface thereof, which arcuate portions are adapted to lie in spaced apart relationship to corresponding arcuate portions along an upper surface of the receptacle 102. The arcuate portions preferably extend collinearly with the longitudinal axis of the adjustable panel 108.

The adjustable panel 108 may suitably also include additional structure for increasing the extent of surface interaction between the adjustable panel 108 and the receptacle 102. In a preferred embodiment, the adjustable panel 108 includes a pair of flange-like arm members (not illustrated) integral with the adjustable panel 108 and extending generally perpendicularly from the edges thereof toward the stationary panel 106. The arm members preferably extend from the adjustable panel 108 in an orientation according to which the inner surface 132 of the adjustable panel 108 and the arm members collectively interface with a rear and side faces of the receptacle 102, thereby increasing the degree of securement between the warming device 100 and the receptacle 102. Even more preferably, the arm members extend only from lower portions of the edges of the adjustable panel 108, thereby resulting in upper portions of the side faces of the receptacle 102 being exposed when the receptacle 102 is secured by the warming device 100, which exposure suitably facilitates removal of the receptacle 102 from the warming device 100.

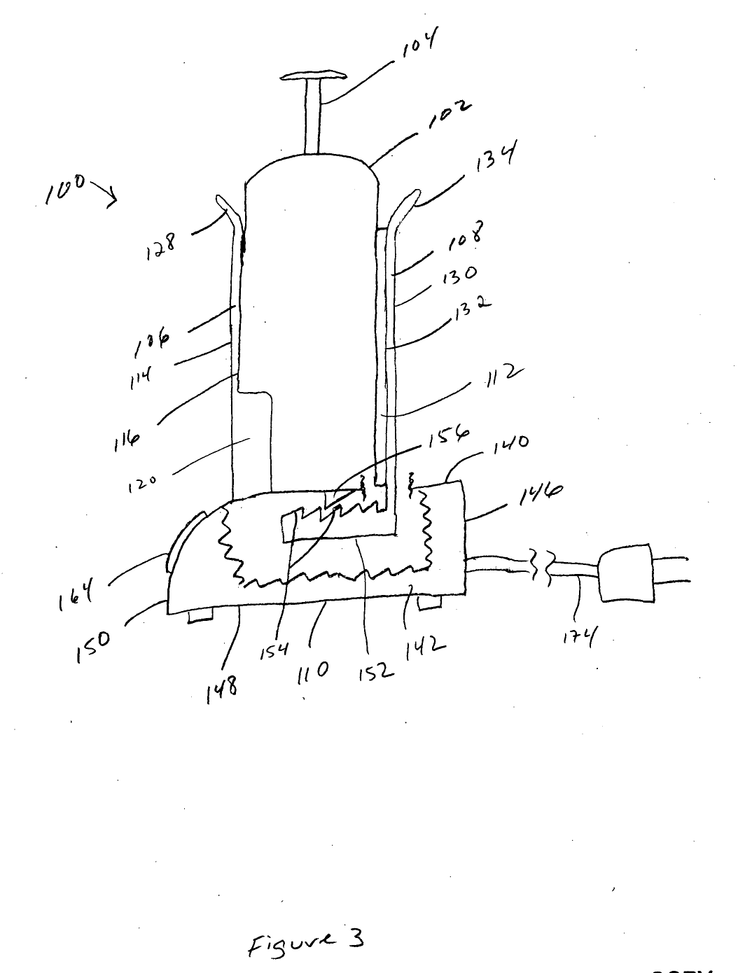

With reference to a preferred embodiment, one or more of the stationary panel 106 and the adjustable panel 108 may suitably include structure for facilitating the receipt of the receptacle 102 therebetween. With reference to FIG. 3, the stationary panel 106 suitably includes a lip member 128 extending from an upper portion thereof in a generally arcuate manner according to which the lip member 128 extends away from the adjustable panel 108. Accordingly, the lip member 128 provides a funnel-like configuration that facilitates the receipt of the receptacle 102 along the inner surface 116 of the stationary panel 106. With continued reference to FIG. 3, the adjustable panel 108 suitably also includes a lip member 134 extending from an upper portion thereof in a generally arcuate manner according to which the lip member 134 extends away from the stationary panel 106. Accordingly, the lip member 134 preferably cooperates with the stationary panel 106 lip member 128 in providing a funnel-like configuration that facilitates the receipt of the receptacle 102 between the stationary panel 106 and the adjustable panel 108.

As previously mentioned, the adjustable panel 108 is preferably moveably adjustable between a range of positions, generally ranging from a position of relative proximity to the stationary panel 106 and a relatively distal position to the stationary panel 106. In a preferred embodiment, the adjustable panel 108 is adjustable according to a generally ratcheting mechanism by which the panel 108 is ratchetable toward the stationary panel 106 and subsequently is moveable away from the stationary panel 106 upon the actuation of a ratcheting disengagement means. Aspects of the adjustment of the adjustable panel 108 will be discussed hereinafter.

It is to be appreciated that the discussion of the means adapted for supporting the fluid-containing receptacle 102, particularly the gripping member and panels 106, 108, is by way of example only and for ease of illustration of a preferred embodiment, and is not to be construed as a limitation on the scope of the present invention. The means adapted for supporting the fluid-containing receptacle 102 may suitably be of any desired structure for supporting any of a plurality of potential configurations for a receptacle. The preferred embodiment of the cooperating panels 106, 108 is a particularly advantageous configurations, as the panels 106, 108 are configured in a particular manner and are adjustably disposable relative to each other so as to accommodate a plurality of receptacle configurations. However, other supporting means are contemplated and are suitable for the purposes of the present invention, such as, for example, a cylindrical slot-like cavity having an open top, a cylindrically elongate cavity having a longitudinally extending slot therein for providing access to the receptacle when supported therein, an elongate rectangular cavity, an elongate ovoid cavity, or any other suitable structure for receiving and supporting a receptacle. Additionally, the warming device 100 need not necessarily include elongate and projecting structure adapted for interfacing with and supporting one or more of the side faces, front face and rear face of the receptacle. By way of example, the warming device 100 may suitably include a simple base member upon which the receptacle is supported along its bottom face. By way of additional example, the warming device 100 may suitably include a single projecting panel member, optionally angularly offset relative to the warming device 100, and adapted for receiving the receptacle 102 laid thereagainst.

With continued reference to FIGS. 1-3, the warming device 100 suitably also includes a base member 110 adapted for supporting the means adapted for supporting the receptacle 102, preferably the stationary panel 106 and the adjustable panel 108. The base member 110 is preferably a generally rectangular member oriented as a component of the warming device 100 so that its longitudinal axis is disposed along a horizontal axis of the device 100. The base member 110 suitably includes opposed and spaced apart, vertically oriented side walls 142, 144, a rear wall 146, a front wall 150, an upper surface 140, and a bottom surface 148. In a preferred embodiment, the side walls 142, 144 and the rear wall 146 extend from the bottom surface 148 and approach the upper surface 140 in a generally perpendicular manner so as to collectively define a generally rectangular overall configuration of the base member 110. In an additionally preferred embodiment, the front wall 150 is preferably provided as an arcuate wall that extends in a convex-like arced manner from the bottom surface 148 toward the upper surface 140.

The upper surface 140 of the base member 110 preferably operates as a situs for the operation of the panels 106, 108 and as a substrate upon which at least a portion of a bottom face of the receptacle 102 is positioned when the receptacle 102 is secured by the device 100. As illustrated in the Figures, the stationary panel 106 preferably extends vertically and generally perpendicularly from a front portion of the upper surface 140. Even more preferably, the stationary panel 106 is a member unitary with the base member 110 and is generally disposed in an orientation according to which its outer surface 114 upwardly projects from the upper surface 140 at a location generally I defined by the interface between the upper surface 140 and the front wall 150. Accordingly, the upwardly terminal portion of the arcuate surface of the front wall 150 suitably terminates at a lower portion of the stationary panel 106. The flange-like arm members 120, 122, if optionally present, suitably each extend from a region of the base member 110 preferably defined by a portion of the interface between the upper surface 140 and the side walls 142, 144.

The adjustable panel 108 is preferably also associated with the upper surface 140 of the base member 110. With reference to FIG. 3 and returning to the discussion of the adjustment of the adjustable panel 108, the adjustable panel 108 is preferably disposed in an adjustable manner relative to the upper surface 140. Preferably, the adjustable panel 108 is adapted to be adjusted along a continuum of positions ranging from a position of relative proximity to the stationary panel 106 to a position relatively distal to the stationary panel 106, which adjustability suitably facilitates the insertion of the receptacle 102 between the panels 106, 108 and the removal of the receptacle 102 from the panels 106, 108. Additionally, the adjustability suitably also enables the warming device 100 to accommodate any of a plurality of receptacle configurations and dimensions, as the adjustable panel 108 may be spaced apart from the stationary panel 106 in any of a range of dimensions so as to accommodate any of a range of receptacle sizes and/or configurations.

With continued reference to FIG. 3, the adjustable panel 108 preferably is adjustable according to a ratcheting-like mechanism according to which the adjustable panel 108 is ratchetable by direct user manipulation toward the stationary panel 106 and is securely maintained in position by the ratcheting mechanism until disengaged by user actuation of a disengagement mechanism. In more detail and with connection to a preferred embodiment, the adjustable panel 108 suitably includes a ratcheting member 152 extending generally perpendicularly from a bottom portion of the panel 108 and disposed at least partially within the base member 110. The ratcheting member 152 suitably includes a plurality of teeth 154 disposed on an upper surface thereof, which teeth 154 suitably cooperate with an engaging member 156 associated with the base member 110. The teeth 154 are preferably oriented on the ratcheting member 152 so that angularly offset portions thereof slope upward and away from the stationary panel 106 and terminal flat (and preferably perpendicular relative to the ratcheting member 152) end portions are disposed distal (relative to the stationary panel 106) relative to the upper portion of each angularly offset portion. Additionally, the engaging member 156 is preferably oriented relative to the base member 110 so that an angularly offset portion thereof slops downward and away from the adjustable panel 108 and a terminal flat (and preferably perpendicular relative to the ratcheting member 152) end portion is disposed proximal to the stationary panel 106. Preferably, the engaging member 156 is associated with an inner face of the base member 110 upper surface 140. In operation, as the adjustable panel 108 is advanced toward the stationary panel 106, the teeth 154 on the ratcheting member 152 slide against the engaging member 156; as each tooth 154 passes the engaging member 152, the terminal flat portion of the engaging member 152 suitably engages the terminal flat portion of a tooth 154, thereby preventing the movement of the adjustable panel 108 away from the stationary panel 106, but still permitting the movement of the adjustable panel 108 toward the stationary panel 106. In this manner, once the receptacle 102 has been positioned between the panels 106, 108, the adjustable panel 108 is moved forward toward the stationary panel 106 until it is in a position that causes the receptacle 102 to be firmly engaged by the panels 106, 108, and the adjustable panel 108 is not able to disengage sua sponte from engagement with the receptacle 102. Despite the discussion of the adjustability of the panel 108, it is to be appreciated that the adjustable panel 108 need not be an adjustable member and may suitably be provided as a stationary panel positioned behind the stationary panel 106, or in any other suitable configuration.

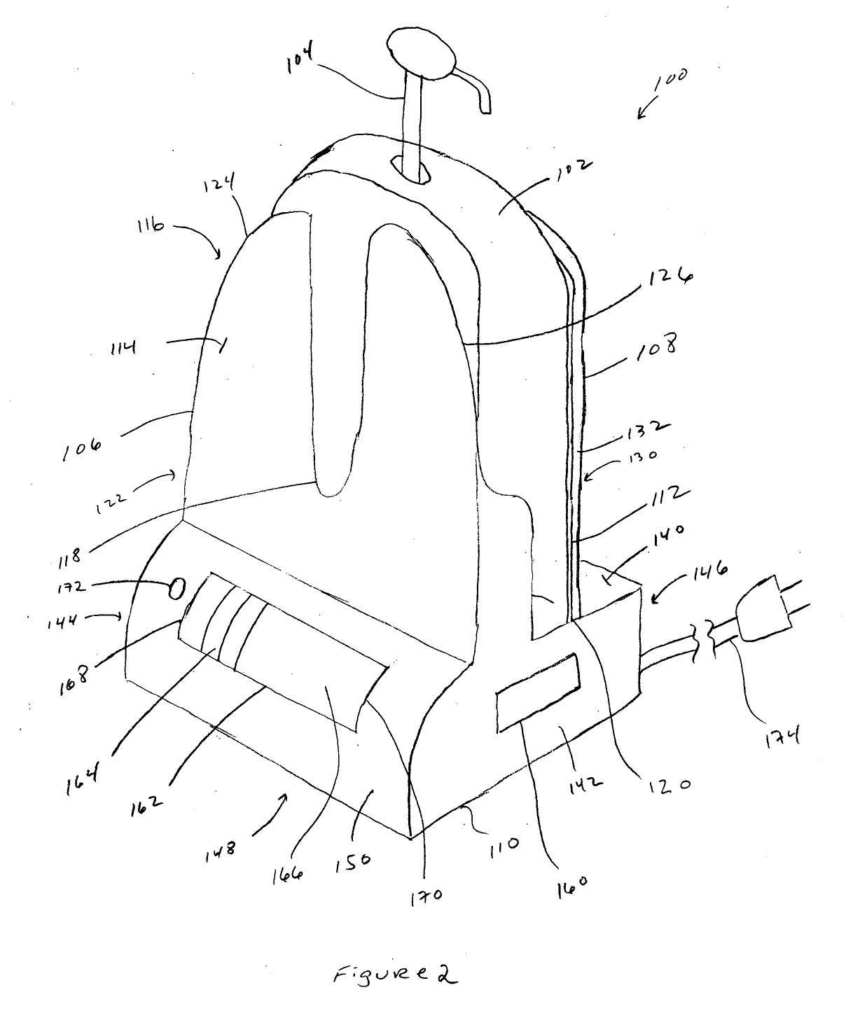

The warming device 100 suitably also includes means adapted for disengaging the adjustable panel 108 from a given position. With reference to FIGS. 1 and 2, the warming device 100 preferably includes a user interface, such as a button 160, depression of which suitably disengages the ratcheting member 152 teeth 154 from the engaging member 156, thereby enabling the separation of the adjustable panel 108 from the stationary panel 106. The button 160 suitably is associated with a lever-like mechanism adapted to receive the depression of the button 160 and translate the depression into a force for downwardly displacing the ratcheting member 152, so as to separate it from the engaging member 156. However, any suitably structure for enabling the selective adjustment of the adjustable panel 108 may be employed, with regard given to the particular configuration of the adjustability of the panel 108.

Returning to a discussion of the base member 110, the bottom surface 148 thereof is preferably a surface of the warming device 100 that interacts with a surface upon which the device 100 is positioned, such as a countertop, a vanity countertop, an upper surface of a clothing dresser, and the like. The bottom surface 148 preferably includes features thereon for increasing the frictional engagement between the warming device 100 and the surface upon which it is position. By way of example, the bottom surface 148 preferably includes projecting therefrom one or more rubber (or other appropriate material) feet-like members adapted to enable the warming device 100 to resist lateral displacement upon its supporting surface. However, any other suitable structure may be employed for aiding in preventing the accidental movement of the warming device 100. The warming device 100 may suitably be alternatively configured so as to be mountable to a wall or other appropriate vertical surface by any suitably fastening mechanism, such as hook and loop fasteners, screws, and the like.

The warming device 100 of the present invention suitably also includes the means adapted for warming the fluid maintained in the receptacle 102. According to a preferred embodiment, the warming means is provided as a resistance warming device 112, preferably disposed in a vertical orientation along the inner surface 132 of the adjustable panel 108. The resistance warming device 112 suitably is the means by which the warming device 100 generates heat and transfers the heat to the fluid maintained in the receptacle 102, thereby warming the same. In more exemplary and preferred detail, the resistance warming device 112 is preferably comprised of a top layer, optionally a bottom layer, and a heating element disposed therebetween. The top layer and bottom layer are preferably substantially flat, thin and rectangular members, being generally mirror images of each other, and constructed of a preferably electrically insulating and durable material. Suitable example materials for the construction of the top and bottom layers include, but are not limited to, vinyl (e.g., Duraflex™, available from Duraflex, Tewkesbury, England), acrylonitrile-budadiene-styrene(ABS) plastic, polyvinylchloride (PVC), polyarylate, polycarbonate, high density polyethylene (HDPE), acrylic-styrene-acrylonitrile (ASA), polystyrene (PS), styrene-acrylonitrile (SAN), polyarylsulfone, and any suitable heat transferable and preferably electrically insulated material. Alternatively, an appropriate metal and/or alloy composition may suitably be employed for the construction of the top and bottom layers.

The heating element of the resistance warming device 112 is preferably a resistance heating element disposed between and generally sandwiched by the top and bottom layers. The resistance heating element is preferably an elongate heating wire sinuously looped throughout the heating mat in a manner that maximizes the amount of heating wire disposed in the mat, thereby increasing its heat-emitting capacity. The resistance heating element is electrically coupled to control circuitry (as will be more fully described hereinafter) and is of any suitable material (such as, for example, an alloy of copper, tin, lead and/or platinum) that operates to dissipate resistance created from a circuit, and thereby generate heat, as known to one of ordinary skill in the art. Example commercially available heating mats and/or heating elements include those available from Calesco, those available under the tradename Performance Master Advantage Plus, and the like.

The resistance warming device 112 may additionally include a reflective insulation pad and/or layer disposed between the heating element and the bottom layer, or in any other configuration suitably for facilitating the directional emanation of heat therefrom. An example reflective insulation pad is suitably constructed from a foil-like material, such as aluminum, and operates to direct the radiation of heat from the heating element upward.

The resistance warming device 112 is preferably associated with control circuitry that suitably couples the resistance warming device 112 to a source of electrical current, enables a user to control and/or direct operation of the resistance heating mat, and/or contains elements that provide certain safety features. The resistance warming device 112 is preferably couplable to a source of electrical current through a conventional electric cord 174 electrically associated with the resistance warming device 112 in a well known manner. The electric cord 174 preferably includes at one end a plug adaptor adapted to be connected to a source of electric current, e.g., 120V AC, one or more batteries, etc. The electrical cord is preferably provided in substantial length to facilitate positioning of the warming device 100 in any desired position. The electrical cord 174 may suitably be retractable into the body of the warming device 100 to simplify storage of the device and to reduce the amount of unneeded cord being exposed from the device. Alternatively, a surface of the device 100, such as the rear wall 146, may suitably include one or more projections protruding therefrom adapted for receiving the electric cord 174 wrapped therearound for convenient storage of the electrical cord. Additionally, a spool-like mechanism may be provided for enabling winding of the electric cord 174 around a spool.

Preferably, the warming device 100 includes means adapted for enabling the warming device 100 to electrically couple to other devices. In a preferred embodiment, the device includes an electrical plug adaptor (not illustrated) integrated therewith and communicatively coupled to the control circuitry in a manner that the adaptor provides a source of electrical current to a second device associated with the warming device 100. Provisioning the warming device 100 with means for coupling the warming device 100 to another device suitably enables the operation of a plurality of devices in a room, such as a bathroom, that normally suffers from a lack of wall mounted electrical outlets. It is to be appreciated that the means for electrically coupling the warming device 100 to another device need to be limited to an electrical plug adaptor and may include any structure adapted to complementarily engage with corresponding structure on another device. The warming device 100 may suitably also include structure for directly interfacing the device 100 with an electric wall outlet, such as a male plug adaptor extending from the base member 110 in a configuration according to which at least a portion of the device 100 is positioned in proximity to, preferably abutting, a portion of a wall.

The control circuitry suitably also includes elements that enable a user to control and/or direct operation of the warming device 100. The control elements generally include one or more means adapted for enabling a user to actuate the flow of electrical current to the resistance warming device 112, thereby activating the same to emanate heat. The means may suitably be provided as a user interface 162 adapted to receive user input and translate the received user input into an actuation of the flow of electric current for the resistance warming device 112. The user interface 162 may be any appropriate device, such as a conventional on/off switch, a pushbutton switch, a rotary dial, a slidable mechanism, and similar devices adapted to be physically manipulated by a user. In a preferred embodiment, the user interface 162 is provided as an element of the base member 110 front face 150 comprising a switch 164 slidable along a slot 166. The switch 164 is preferably slidable from a first end 168 of the slot 166, along a middle continuum of the slot 166, and to a second end 170 of the slot 166. The switch 164 is preferably associated with a rheostat-like device according to which positioning of the switch 164 at or near the first end 168 prevents the flow of electric current to the resistance warming device 112 and positioning of the switch 164 at or near the second end 170 suitably causes a maximum amount of current to flow to the resistance warming device 112. As the switch 164 is displaced away from the second end 170 and toward the first end 168, the amount of current flowing to the resistance warming device 112 suitably decreases.

The user interface 162 may suitably be coupled to a means, responsive to the user input, adapted for preventing the flow of electric current to the resistance warming device 112 after a predetermined period of time. For example, the user interface 162 may be coupled to a timer-like mechanism that is activated in response to the actuation of the user interface 162 and suitably causes electrical current to flow to the resistance warming device 112 for a predetermined period of time. Upon the expiration of the predetermined period of time, the flow of electrical current to the resistance warming device 112 is discontinued, thereby eliminating the generation of heat thereby. The predetermined period of time may be an automatic feature built in to the warming device 100 during construction and/or assembly, according to which activation of the user interface 162 automatically directs operation of the resistance warming device 112 for the predetermined period of time. Alternatively, the predetermined period of time may suitably be manually inputtable by the user by, for example, a rotary knob-like device adapted to be turned and/or set with reference to one of a plurality of time durations, such as five minutes, ten minutes, thirty minutes, and the like. Any appropriate device may suitably be employed for enabling a user to preselect a duration for heating, such as a rheostat-like slide, and the like.

The user interface 162 may suitably also include a programmable interface adapted for receiving user-generated instructions for operation of the warming device 100 and for automatically executing the heating in accordance with the instructions. Many individuals follow well established routines, such as, for example, always performing morning ablutions in preparation for a workday at 6:30 AM during workdays. Accordingly, the programmable interface is adapted to be programmed with user generated instructions for automating the actuating of the warming device 100. With continued reference to the foregoing example, such user generated instructions may direct the warming device 100 to activate every Monday through Friday at precisely 6:30 AM, or a time shortly thereafter, and for a predetermined duration, e.g., seven minutes, all selected to coincide with, for example, the individual's typical exit from a shower so that the individual is presented with warm body lotion upon the exit. The user programmable mechanism is any conventionally known user programmable mechanism adapted for accomplishing the foregoing aims, such as, for example, a data processing device, and the like.

The user interface 162 may additionally comprise means adapted for providing certain information to the user. For example, the interface 162 may include means adapted for informing the user when the warming device 100 is active and heating fluid. Such means may include, for example, a light emitting diode (“LED”) 172 coupled to the control circuitry and adapted to be illuminated when current is passing to the resistance warming device 112. Additionally, the LED 172 may suitably be positioned in proximity to a written indicium, such as a “heating” indicium that enables a user to readily understand the information being conveyed by the LED 172. Additional information providing means may be provided, such as an LED adapted to inform when the device is in a cool down mode, etc.

The control circuitry suitably also includes protective elements adapted for governing various aspects of the operation of the resistance warming device 112. In connection with the example embodiment in which the user interface comprises a timer-like element, the timer provides certain safety advantages for operation of the warming device 100. For example, the timer ensures that the device is activated only upon user-generated input into the user interface 162. By way of additional example, the timer also ensures that the device 100 is activated for only the preselected period of time, thereby protecting against any risks associated with prolonged activation of the device 100.

With continued reference to protective elements, the control circuitry may additionally comprise a temperature cutoff switch, such as a bimetallic over temperature cutoff switch, having a temperature sensor adapted to sense the temperature of the resistance heating device 112 and/or the environment of the resistance heating device 112. The switch is a conventional switch, preferably responsive to a preselected temperature value and adapted to prevent the flow of current to the resistance heating device 112 upon attainment of the preselected temperature value. Preventing the flow of current under these conditions suitably prevents overheating and possible damage to the components of the receptacle 102, the warming device 100, and the environment of the device 100. Other components may additionally be associated with the control circuitry, such as ground fault circuit interrupter (GFCI) components, general components adapted for resisting the deleterious impact of water, and the like.

It is to be appreciated that the means adapted for warming the fluid maintained in the receptacle 102 may be provided as any suitably device and in any suitable configuration. For example, the warming means is preferably provided as the resistance warming device 112. More preferably, the resistance warming device 112 is preferably disposed along a portion of, more preferably substantially all of, the inner surface 132 of the adjustable panel 108. In this configuration, the receptacle 102 maintained between the panels 106, 108 is preferably exposed to a large volume of heat and a large amount of heat emanating surface, as the resistance warming device 112 is preferably disposed along a portion of, more preferably substantially all of, the rear vertical face of the receptacle 102. However, it is to be appreciated that the resistance warming device 112 need not include both a top layer and a bottom layer. Accordingly, the resistance warming device 112 may suitably include the top layer associated with the adjustable panel 108 inner surface 132, with the resistance heating element being disposed between the top layer and the inner surface 132. By way of additional example, the resistance warming device 112 may suitably include projecting and adjustable flange-like members extending from lateral edges thereof, which flanges suitably include a portion of the heating element therein and are adjustable so as to be positioned around side walls of the receptacle 102 so as to increase the amount of heat being transmitted to the fluid maintained therein.

In connection with an alterative embodiment, the resistance warming device 112 may suitably be disposed along the upper surface 140 of the base member 110 in a position for radiating heat upward into the receptacle 102. Alternatively, the resistance heating device 112 may suitably be disposed along both the upper surface 140 of the base member 110 and along the inner surface 132 of the adjustable panel 108. The resistance heating device 112 may suitably be located at and/or positioned in association with the heating device 100 in any suitable location for providing a desired amount of heat transfer to the receptacle 102.

It is to be appreciated that any suitable heating element may be employed as the means adapted for warming the fluid maintained in the receptacle 102. By way of example only, the warming means may suitably be provided as any electric heating element, such as a microwave heating element, an electric light bulb, a resistance coil heater, any conventional electric heating element, and the like. By way of additional example, the warming means may suitably be provide as a conventional fluid-based warming system, such as an oil-based system, a gel-based system, a wax-based system, and the like, the configuration, constituency and operation of any of which is well known to a person of ordinary skill in the art.

Although the invention has been described with regard to certain preferred example embodiments, it is to be understood that the present disclosure has been made by way of example only, and that improvements, changes and modifications in the details of construction and the combination and arrangement of parts may be resorted to without departing from the spirit and scope of the invention. Such improvements, changes and modifications within the skill of the art are intended to be covered by the scope of the appended claims.

1. A body lotion warming device adapted to receive and support a commercially provided body lotion-containing receptacle and to warm the body lotion maintained therein so that the body lotion may be withdrawn therefrom in a warmed state, wherein the warming device comprises:
securing means adapted for securing a fluid-containing receptacle; and
warming means, associated with the securing means, adapted for warming the fluid maintained in the fluid-containing receptacle, and
wherein the securing means comprises a base member adapted for receiving the receptacle thereon, and wherein the securing means additionally comprises a first substantially vertically oriented panel, associated with the base member in a substantially perpendicular manner, adapted to interface with at least a portion of a front face of the receptacle, when the receptacle is secured by the device, and a second substantially vertically oriented panel, associated with the base member in a substantially perpendicular manner, adapted to interface with at least a portion of a rear face of the receptacle, when the receptacle is secured by the device, and wherein the second panel is adjustable relative to the first panel along a continuum of positions disposed on the base member.

2. (canceled)

3. (canceled)

4. The body lotion warming device of claim 1, wherein at least one of the first panel and the second panel is constructed from a transparent material.

5. (canceled)

6. The body lotion warming device of claim 1 further comprising means adapted for maintaining the second panel in a preselected position.

7. The body lotion warming device of claim 1 further comprising releasing means adapted for releasing the second panel from the preselected position to enable adjustment thereof.

8. The body lotion warming device of claim 1, wherein the warming means comprises at least one of an electric heating element and a fluid-based heating element.

9. The body lotion warming device of claim 8, wherein the electric heating element is at least one of a resistance heating element, a microwave heating element, and an oil-based heat generating system.

10. The body lotion warming device of claim 8, wherein the warming means is associated with at least one of the first panel and the second panel.

11. A warming device adapted to receive and support a commercially provided fluid-containing receptacle and to warm the fluid maintained therein so that the fluid may be withdrawn therefrom in a warmed state, wherein the device comprises:
securing means adapted for securing a fluid-containing receptacle; and
warming means, associated with the securing means, adapted for warming the fluid maintained in the fluid-containing receptacle, and
wherein the securing means comprises a base member adapted for receiving the receptacle thereon, a first substantially vertically oriented panel, associated with the base member in a substantially perpendicular manner, adapted to interface with at least a portion of a front face of the receptacle, when the receptacle is secured by the device, and a second substantially vertically oriented panel, associated with the base member in a substantially perpendicular manner, adapted to interface with at least a portion of a rear face of the receptacle, when the receptacle is secured by the device, and wherein at least one of the first panel and the second panel is constructed from a transparent material, and wherein the second panel is adjustable relative to the first panel along a continuum of positions disposed on the base member.

12. (canceled)

13. (canceled)

14. (canceled)

15. The warming device of claim 11 further comprising means adapted for maintaining the second panel in a preselected position and releasing means adapted for releasing the second panel from the preselected position to enable adjustment thereof.

16. The warming device of claim 11, wherein the warming means comprises at least one of an electric heating element and a fluid-based heating element.

17. The warming device of claim 16, wherein the warming means is associated with at least one of the first panel and the second panel.

18. A body lotion warming device adapted to receive and support a commercially provided body lotion-containing receptacle and to warm the body lotion maintained therein so that the body lotion may be withdrawn therefrom in a warmed state, wherein the warming device comprises:
a base member adapted for receiving the receptacle thereon;
a first panel, associated with the base member, adapted to interface with at least a portion of a front face of the receptacle;
a second panel, associated with the base member, adapted to interface with at least a portion of a rear face of the receptacle, wherein the second panel is adjustable relative to the first panel along a continuum of positions disposed on the base member;
warming means, associated with at least one of the first panel and the second panel, adapted for warming the fluid maintained in the fluid-containing receptacle; and
coupling means adapted for coupling the warming means to a source of electrical current.

19. The body lotion warming device of claim 18, wherein at least one of the first panel and the second panel is constructed from a transparent material.

20. The body lotion warming device of claim 18, wherein the warming means comprises at least one of an electric heating element and a fluid-based heating element.
